(19) United States
(12) Patent Application Publication
(10) Pub. No.: US 2015/0135187 A1
(43) Pub. Date: May 14, 2015

(54) METHOD FOR MONITORING RESOURCES IN COMPUTING DEVICE, AND COMPUTING DEVICE

(71) Applicant: TEEMSTONE, Seoul (KR)

(72) Inventors: Bum Sik Lee, Seongnam-si (KR); Chang Won Seol, Seongnam-si (KR); Ja Heon Ku, Seoul (KR)

(21) Appl. No.: 14/398,378

(22) PCT Filed: May 2, 2013
(86) PCT No.: PCT/KR2013/003809

§ 371 Date: Oct. 31, 2014

(30) Foreign Application Priority Data
May 2, 2012 (KR) 10-2012-0046082

(51) Int. Cl. G06F 9/50

(52) U.S. Cl. CPC G06F 9/5005
USPC 718/104

(57) ABSTRACT

A resource monitoring method comprises the steps of: generating process information including a process identifier, process user, process name, CPU usage, and IO usage; determining at least one first process having the same process user and process name from among a plurality of processes currently being executed;

generating first group process information including a group process identifier, total CPU usage, and total IO usage of the determined at least one first process; and monitoring resources of the computing device in units of the generated first group process information.

### TECHNICAL FIELD

The present invention relates to a resource monitoring technology and to a resource monitoring method being performed on multitasking based computing apparatus and computing apparatus.

### BACKGROUND ART

Recently, a computer system performance is very rapidly developed with a development of an IT industry. A resource of the computer system is managed by an operating system. The operating system corresponds to a system software being operated as an interface between a user and a computer hardware to control an input, output and usage of a memory, a disc and a plurality of external devices and to cause a program to usefully use a hardware.

The operating system manages a CPU occupying way, a memory, a file system of programs to provide an execution environment of the program.

Korean Publication Patent No. 10-2009-0081749 relates to a method and an apparatus monitoring an application program resource, the method and apparatus may monitor the application program resource based on a single process configured with a plurality of threads.

Korean Publication Patent No. 10-2010-0122168 relates to a system monitoring computer system resource, the system may provide whether each devices configuring computer system is an abnormal condition and a managing method of the abnormal condition.

### TECHNICAL PROBLEM

Example embodiments of the present invention propose a method of monitoring resource being performed on a multitasking based computing apparatus and an apparatus of performing the same.

Example embodiments of the present invention propose a method of monitoring a computing apparatus resource by group process information having a same process user and same process name and an apparatus performing the same.

Example embodiments of the present invention propose a method of monitoring a computing apparatus resource by group process information having a same pattern parameter of process group parameter and an apparatus performing the same.

### TECHNICAL SOLUTION

In some embodiments, a resource monitoring method, the method being performed on a multitasking based computing apparatus, the method includes (a) generating process information including a process identifier, a process user, a process name, a CPU usage and an IO usage when a computer program is executed, (b) determining at least one first process having a same process user and same process name of a plurality of processes being currently executed, (c) generating first group process information including a group process identifier, a total CPU usage and a total IO usage for the determined at least one first process and (d) monitoring the resource of the computing apparatus by the generated first group process information.

In one embodiment, the method may further include repeating the (a) step through (d) step by a specific period or upon a user request.

In one embodiment, generating the process information may further include a process group parameter to the process information and the process group parameter inputted with the process name in an execution procedure of the computer program. Herein, the (b) step may further include determining at least one second process having a same pattern parameter of a process group parameter from the process information.

In one embodiment, the (c) step may further include generating second group process information including a group process identifier, a total CPU usage and a total IO usage for the determined at least one second process. Herein, the (d) step may further include monitoring the resource of the computing apparatus by the generated second group process information. Herein, the (c) step may exclude a process in the second group process information from the generated first group process information to include recalculating the total CPU usage and the IO usage.

In one embodiment, a multitasking based computing apparatus, the apparatus performing resource monitoring, the apparatus includes a process information generating unit configured to generate process information including a process identifier, a process user, a process name, a CPU usage and an IO usage when a computer program is executed, a group process information generating unit configured to determine at least one first process having a same process user and same process name of a plurality of processes being currently executed and to generate first group process information including a group process identifier, a total

CPU usage and a total IO usage for the determined at least one first process and a resource monitoring unit configured to monitor the resource of the computing apparatus by the generated first group process information.

In one embodiment, the process information generating unit may further include a process group parameter to the process information and the process group parameter inputted with the process name in the execution procedure of the computer program. Herein, group process information generating unit may determine at least one second process from the process information, the at least one second process having a same pattern parameter of the process group parameter and may further generate second group process information including a group process identifier, a total CPU usage and a total IO usage for the determined at least one second process.

In one embodiment, a resource monitoring unit may monitor the resource of the computing apparatus by the generated second group process information. Herein, the group process information generating unit may exclude a process in the second group process information from the generated first group process information to recalculate the total CPU usage and the IO usage.

### TECHNICAL EFFECTS

A resource monitoring method being performed on computing apparatus and computing apparatus according to example embodiments of the present invention may provide a resource monitoring method being performed on multitasking based computing apparatus and an apparatus performing the same.

A resource monitoring method being performed on computing apparatus and computing apparatus according to example embodiments of the present invention may provide a resource monitoring method and an apparatus performing the same, the method monitors a resource of computing apparatus by group process information having a same process user and same process name.

A resource monitoring method being performed on computing apparatus and computing apparatus according to example embodiments of the present invention may provide a resource monitoring method and an apparatus performing the same, the method monitors a resource of computing apparatus by group process information having a same pattern parameter of process group parameter.

### DESCRIPTION OF DRAWINGS

FIG. 1 is a block diagram illustrating a computing apparatus according to an example embodiment of the present invention.

FIG. 2 is an example diagram of process information generated by a process information generating unit in FIG. 1.

FIG. 3 is an example diagram of first group process information generated by a group process information generating unit in FIG. 1.

FIG. 4 is an example diagram of process information generated a process information generating unit in FIG. 1.

FIG. 5 is an example diagram of second group process information generated by a group process information generating unit in FIG. 1.

FIG. 6 is an example diagram of first group process information generated a group process information generating unit in FIG. 1.

FIG. 7 is a flowchart illustrating a resource monitoring procedure being performed on a computing apparatus according to an example embodiment of the present invention.

### MODE FOR INVENTION

The embodiments and the configurations depicted in the drawings are illustrative purposes only and do not represent all technical scopes of the invention, so it should be understood that various equivalents and modifications may exist at the time of filing this application. Although a preferred embodiment of the disclosure has been described for illustrative purposes, those skilled in the art will appreciate that various modifications, additions and substitutions are possible, without departing from the scope and spirit of the invention as disclosed in the accompanying claims.

Terms and words used in the specification and the claims shall be interpreted as to be relevant to the technical scope of the invention based on the fact that the inventor may property define the concept of the terms to explain the invention in best ways.

The terms “first” and “second” can be used to refer to various components, but the components may not be limited to the above terms. The terms will be used to discriminate one component from the other component. For instance, the first component may be referred to the second component and vice versa without departing from the right of the disclosure.

When a component is referred to as being “connected to” or “linked to” another component, the component may be directly connected to or linked to another component or an intervening component may be present therebetween. In contrast, if a component is referred to as being “directly connected to” or “directly linked to” another component, an intervening component may not be present therebetween.

The terms used in the specification are for the purpose of explaining specific embodiments and have no intention to limit the disclosure. Unless the context indicates otherwise, the singular expression may include the plural expression. In the following description, the term “include” or “has” will be used to refer to the feature, the number, the step, the operation, the component, the part or the combination thereof without excluding the presence or addition of one or more features, the numbers, the steps, the operations, the components, the parts or the combinations thereof.

Identification letters (e.g., a, b, c, etc.) in respective steps or operations are used for the sake of explanation and do not describe any particular order. The respective operations may be changed from a mentioned order unless specifically mentioned in context. Namely, respective steps may be performed in the same order as described, may be substantially simultaneously performed, or may be performed in reverse order.

The present invention may be implemented as machine-readable codes on a machine-readable medium. The machine-readable medium includes any type of recording device for storing machine-readable data. Examples of the machine-readable recording medium include a read-only memory (ROM), a random access memory (RAM), a compact disk-read only memory (CD-ROM), a magnetic tape, a floppy disk, and optical data storage. The medium may also be carrier waves (e.g.,

Internet transmission). The computer-readable recording medium may be distributed among networked machine systems which store and execute machine-readable codes in a de-centralized manner.

The terms used in the present application are merely used to describe particular embodiments, and are not intended to limit the present invention. Unless otherwise defined, all terms used herein, including technical or scientific terms, have the same meanings as those generally understood by those with ordinary knowledge in the field of art to which the present invention belongs. Such terms as those defined in a generally used dictionary are to be interpreted to have the meanings equal to the contextual meanings in the relevant field of art, and are not to be interpreted to have ideal or excessively formal meanings unless clearly defined in the present application.

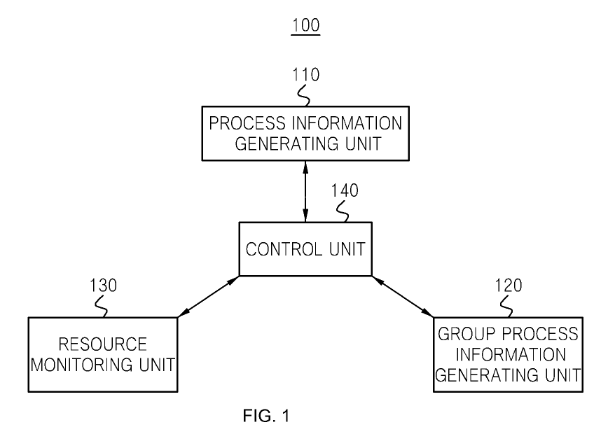

FIG. 1 is a block diagram illustrating a computing apparatus according to an example embodiment of the present invention.

Referring to FIG. 1, the computing apparatus 100 includes a process information generating unit 110, a group process information generating unit 120, resource monitoring unit 130 and a control unit 140.

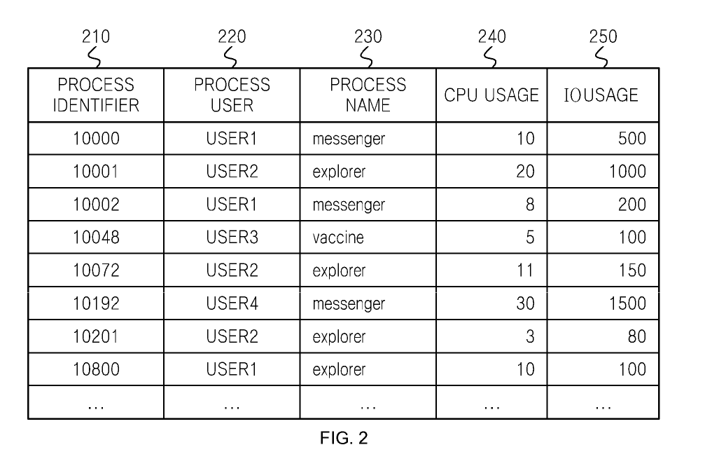

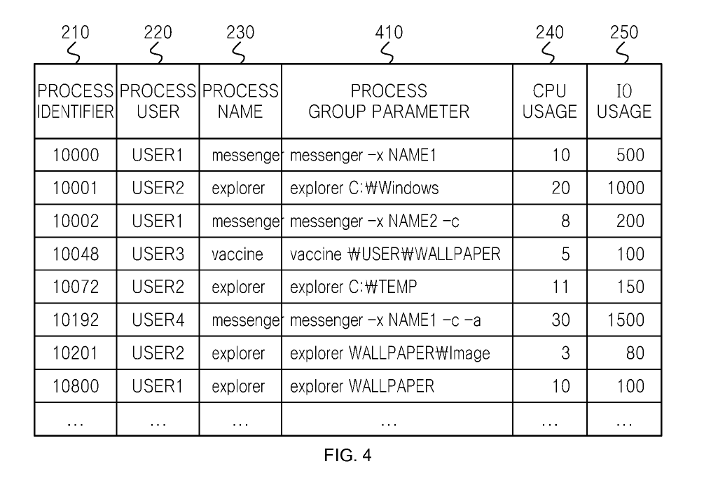

The process information generating unit 110 may generate process information including a process identifier 210, a process user 220, a process name 230, a CPU usage 240 and an IO usage 250 when a computer program is executed. This will be described referring to FIG. 2. In one embodiment, the process information generating unit 110 may further include a process group parameter 410 to process information and the process group parameter 410 is inputted with the process name 230 in an execution procedure of the computer program. This will be described referring to FIG. 4.

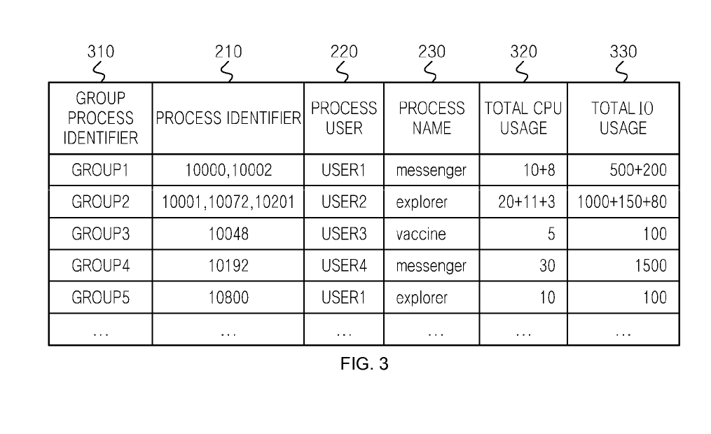

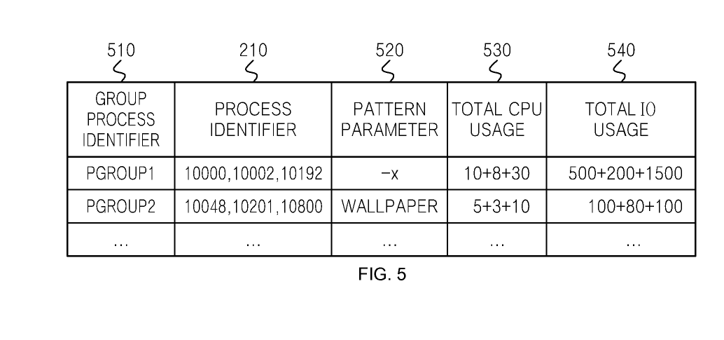

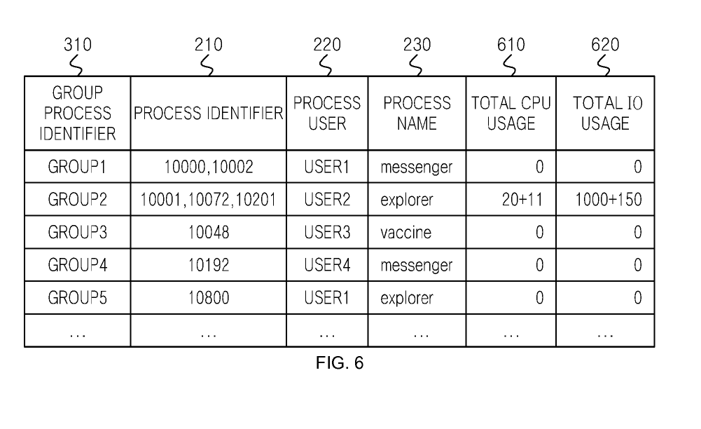

The group process information generating unit 120 may determine at least one first process having a same process user 220 and same process name 230 of a plurality of processes being currently executed to generate first group process information including a group process identifier 310, a total CPU usage 320 and a total IO usage 330 for the determined at least one first process. This will be described referring to FIG. 3. In one embodiment, the group process information generating unit 120 may determine at least one second process from the process information, the at least one second process having a same pattern parameter 520 of the process group parameter 410 to generate second group process information including a group process identifier 510, a total CPU usage 530 and a total IO usage 540 for the determined at least one second process. This will be described referring to FIG. 5. Herein, the group process information generating unit 120 may exclude a process in the second group process information from the generated first group process information to recalculate the total CPU usage 320 and the IO usage 330. This will be described referring to FIG. 6.

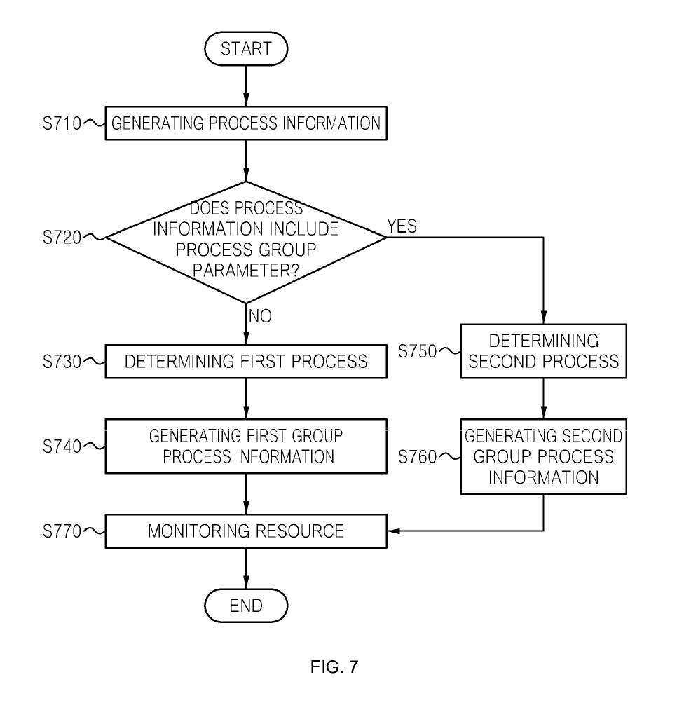

The resource monitoring unit 130 may monitor the resource of the computing apparatus by the generated first group process information. In one embodiment, the resource monitoring unit 130 may monitor the resource of the computing apparatus by the generated second group process information. This will be described referring to step S770 of FIG. 7

The control unit 140 may control an overall operation of the computing apparatus 100 and may control a control flow or a data flow among the process information generating unit 110, a group process information generating unit 120 and resource monitoring unit 130.

FIG. 2 is an example diagram of process information generated by the process information generating unit in FIG. 1

The process information generating unit 110 may generate the process information including the process identifier 210, the process user 220, the process name 230, the CPU usage 240 and the IO usage 250.

In more detail, the process information generating unit 110 may respectively generate information for the CPU usage 240 and the IO usage 250 of the process name 230 executed by each of process user 220. Herein, the process user 220 executing the process may correspond to at least one of all users executing the process on computing apparatus and the executed process name 230 may correspond to at least one of all process names being executed on computing apparatus. The process information generating unit 110 may assign the process identifier 210 for the process name 230 executed by each of the process user 220 and may generate information for the CPU usage 240 and the IO usage 250 of each of the process identifier 210.

For example, in FIG. 2, the process information generating unit 110 may assign a process identifier 210 {10000} for a messenger process 230 executed by a user1 220 and may calculate a CPU usage 240 and an IO usage 250 for the process identifier 210 to generate a data of {10} and {500}.

FIG. 3 is an example diagram of first group process information generated by a group process information generating unit in FIG. 1.

First, the group process information generating unit 120 may determine at least one first process having the same process user 220 and same process name 230 of a plurality of processes being currently executed. For example, the group process information generating unit 120 may determine a first process for a messenger process having a same process name 230 executed by a process user 220, the process user 220 may correspond to a USER1 in the process information illustrated in

FIG. 2. That is, the group process information generating unit 120 may determine a process as a first process and the process corresponds to the process identifier 210 {10000} and {10002}.

Next, the group process information generating unit 120 may generate first group process information including a group process identifier 310, a total CPU usage 320 and a total IO usage 330 for the determined at least one first process. In more detail, the group process information generating unit 120 may assign a group process identifier 310 for at least one first process having a same process user 220 and same process name 230 and may calculate a total CPU usage 320 and a total IO usage 330 for the group process identifier 310 to generate a data.

For example, in FIG. 3, the group process information generating unit 120 may assign a group process identifier 310 {GROUP1} for a process identifier 210 {10000} and {10002} having a same process user 220 and same process name 230 in the process information illustrated in FIG. 2. Herein, the group process information generating unit 120 may calculate a total CPU usage (10+8=18) and a total IO usage (500+200=700) for the group process identifier 310 GROUP1 to generate a data.

FIG. 4 is an example diagram of process information generated a process information generating unit in FIG. 1.

The process information generating unit 110 may generate a process group parameter 410 in process information and the process group parameter 410 is inputted with the process name 230 in an execution procedure of the computer program.

In more detail, the process information generating unit 110 may generate process information including the process identifier 210, the process user 220, the process name 230, the CPU usage 240 and the IO usage 250 when the computer program is executed as described in FIG. 2. At this time, the process information generating unit 110 may generate process information including a process group parameter 410 inputted with the process name 230. In one embodiment, the process group parameter 410 may correspond to a process argument generated at a time when a process is executed. In another embodiment, the process group parameter 410 may be inputted by a user at a time when a process is executed.

For example, in FIG. 4, the process information generating unit 110 may assign a process identifier 210 {10000} for a messenger process 230 executed by a USER1 220 and may calculate a CPU usage 240 and an IO usage 250 for the process identifier 210 to generate a data of {10} and {500}. Herein, the process information generating unit 110 may generate process information including a process argument {messenger −x NAME1}, the process argument {messenger −x NAME1} corresponds to a process group parameter 410 inputted at a time when the messenger process 230 is executed.

FIG. 5 is an example diagram of second group process information generated by a group process information generating unit in FIG. 1.

First, the group process information generating unit 120 may determine at least one second process from the process information, the at least one second process having a same pattern parameter 520 of the process group parameter 410. In one embodiment, the pattern parameter 520 may be set by a resource monitoring manager and may be implemented as a plurality. In another embodiment, the group process information generating unit 120 may automatically set the pattern parameter 520.

In more detail, when the process group parameter 410 corresponds to a process argument, the group process information generating unit 120 may set a process as a group and the process has a specific pattern parameter 520 of the process group parameter 410. In one embodiment, the specific pattern parameter 520 may be set by the resource monitoring manager so that the group process information generating unit 120 may determine a process as a second process, the process includes a specific pattern parameter 520 (e.g. a specific characteristic string) of the process argument. Herein, when the pattern parameter 520 is implemented as a plurality, the group process information generating unit 120 may determine a plurality of second processes including each of pattern parameter 520.

For example, in FIG. 5, the group process information generating unit 120 may determine a process as a second process and the process has a pattern parameter 520 corresponding to {−x} of the process group parameter 410 in the process information illustrated in FIG. 4. That is, the group process information generating unit 120 may determine a process as a second process and the process corresponds to a process identifier 210 {10000}, {10002} and {10192} including a {−x} characteristic string of process group parameter 410. In one embodiment, when the pattern parameter corresponds to {none}, the group process information generating unit 120 may determine all processes as a second process and the processes do not include a set pattern parameter 520.

Next, the group process information generating unit 120 may generate second group process information including a group process identifier 510, a total CPU usage 530 and a total IO usage 540 for a determined at least one second process. In more detail, the group process information generating unit 120 may assign a group process identifier 510 for the second process having a same pattern parameter 520 and may calculate a total CPU usage 530 and a total IO usage 540 for the group process identifier 510 to generate a data.

For example, in FIG. 5, the group process information generating unit 120 may assign a group process identifier 510 {PGROUP1} for a second process having a pattern parameter 410 {−x} in the process information illustrated in FIG. 4. Herein, the group process information generating unit 120 may calculate a total CPU usage 530 and a total IO usage 540 for the group process identifier {PGROUP1} to generate a data corresponding to {10+8+30} and {500+200+1500}. In one embodiment, when the pattern parameter 520 corresponds to {none}, the group process information generating unit 120 may calculate a total CPU usage 530 and a total IO usage 540 for a second process including all processes to generate a data and the processes do not include a set pattern parameter 520.

FIG. 6 is an example diagram of first group process information generated a group process information generating unit in FIG. 1.

The group process information generating unit 120 may exclude a process in the second group process information from the generated first group process information to recalculate a total CPU usage 610 and a total IO usage 620.

In more detail, the group process information generating unit 120 may determine at least one first process having a same process user 220 and same process name 230 of a plurality of processes currently executed as illustrated in FIG. 3. Herein, the group process information generating unit 120 may determine at least one second process from the process information and the at least one second process has a same pattern parameter 520 of the process group parameter 410. The group process information generating unit 120 may generate second group process information including a group process identifier 510, a total CPU usage 530 and a total IO usage 540 for the determined at least one second process. Herein, the group process information generating unit 120 may exclude a process in the second group process information from the generated first group process information to recalculate the total CPU usage 610 and the total IO usage 620.

For example, in FIG. 6, a rest process excluding the process in the second group process information from the first group process information illustrated in FIG. 3 corresponds to a process identifier {10001} and {10072}. Herein, the group process information generating unit 120 may calculate a total CPU usage 610 and a total IO usage 620 corresponding to the process identifier {10001} and {10072} to generate a date corresponding to {20+11} and {1000+150}.

FIG. 7 is a flowchart illustrating a resource monitoring procedure being performed on a computing apparatus according to an example embodiment of the present invention.

The process information generating unit 110 generates process information including a process identifier 210, a process user 220, a process name 230, a CPU usage 240 and an IO usage 250 when a computer program is executed (Step S710).

In more detail, the process information generating unit 110 respectively generates information for the CPU usage 240 and the IO usage 250 of the process name 230 being executed by each of process user 220. Herein, the process user 220 executing the process may correspond to at least one of all users executing the process on computing apparatus and the executed process name 230 may correspond to at least one of all process names being executed on computing apparatus. The process information generating unit 110 may assign the process identifier 210 for the process name 230 executed by each of the process user 220 and may generate the information for the CPU usage 240 and the IO usage 250 for each of the process identifier 210.

For example, in FIG. 2, the process information generating unit 210 may assign the process identifier 210 {10000} for the messenger process 230 executed by USER1 220 and may calculate the CPU usage 240 and the IO usage 250 for the process identifier to generate the data.

In one embodiment, the process information generating unit 110 may generate the process group parameter 410 to the process information and the process group parameter 410 is inputted with the process name 230 in the execution procedure of the computer program.

In more detail, the process information generating unit 110 may generate process information including the process identifier 210, the process user 220, the process name 230, the CPU usage 240 and the IO usage 250 when the computer program is executed as described in FIG. 2. At this time, the process information generating unit 110 may generate process information including the process group parameter 410 inputted with the process name 230. In one embodiment, the process group parameter 410 may correspond to the process argument generated at a time when the process is executed. In another embodiment, the process group parameter 410 may be inputted by the user at a time when the process is executed.

For example, in FIG. 4, the process information generating unit 110 may assign the process identifier 210 {10000} for the messenger process 230 executed by the USER1 220 and may calculate the CPU usage 240 and the IO usage 250 for the process identifier 210 to generate the data of {10} and {500}. Herein, the process information generating unit 110 may generate the process information including the process argument {messenger −x NAME1} and the process argument {messenger −x NAME1} corresponds to the process group parameter 410 inputted at a time when the messenger process 230 is executed.

The group process information generating unit 120 decides whether the process information includes the process group parameter 410 (Step S720).

When the process information do not include the process group parameter 410, the group process information generating unit 120 may determine at least one first process having the same process user 220 and same process name 230 of a plurality of processes being currently executed (Step S730). For example, the group process information generating unit 120 may determine the messenger process as the first process from the process information illustrated in FIG. 2 and the messenger process has the same process name 230 executed by the process user 220 corresponding to the USER1. That is, the group process information generating unit 120 may determine the process as the first process and the process corresponds to the process identifier 210 {10000} and {10002}.

The group process information generating unit 120 may generate the first group process information including the group process identifier 310, the total CPU usage 320 and the total IO usage 330 for the determined at least one first process (Step S740). In more detail, the group process information generating unit 120 may assign the group process identifier 310 for at least one first process having the same process user 220 and same process name 230 and may calculate the total CPU usage 320 and the total IO usage 330 for the group process identifier 310 to generate the data.

For example, in FIG. 3, the group process information generating unit 120 may assign the group process identifier 310 {GROUP1} for the process identifier 210 {10000} and {10002} having the same process user 220 and same process name 230 in the process information illustrated in FIG. 2. Herein, the group process information generating unit 120 may calculate the total CPU usage (10+8=18) and the total IO usage (500+200=700) for the group process identifier GROUP1 to generate the data.

When the process information includes the process group parameter 410, the group process information generating unit 120 may determine at least one second process from the process information and the at least one second process has the same pattern parameter 520 of the process group parameter 410 (Step S750). In one embodiment, the pattern parameter 520 may be set by the resource monitoring manager and may be implemented as a plurality. In another embodiment, the group process information generating unit 120 may automatically set the pattern parameter 520.

In more detail, when the process group parameter 410 corresponds to the process argument, the group process information generating unit 120 may set the process as the group and the process has the specific pattern parameter 520 of the process group parameter 410. In one embodiment, the specific pattern parameter 520 may be set by the resource monitoring manager so that the group process information generating unit 120 may determine the process as the second process, the process includes the specific pattern parameter 520 (e.g. a specific characteristic string) of the process argument. Herein, when the pattern parameter 520 is implemented as a plurality, the group process information generating unit 120 may determine a plurality of second processes including each of pattern parameter 520.

For example, in FIG. 5, the group process information generating unit 120 may determine the process as the second process and the process has the pattern parameter 520 corresponding to {−x} of the process group parameter 410 in the process information illustrated FIG. 4. That is, the group process information generating unit 120 may determine the process as the second process and the process corresponds to the process identifier 210 {10000}, {10002} and {10192} including the {−x} characteristic string of process group parameter 410. In one embodiment, when the pattern parameter corresponds to {none}, the group process information generating unit 120 may determine all processes as the second process and the processes do not include the set pattern parameter 520.

The group process information generating unit 120 may generate the second group process information including the group process identifier 510, the total CPU usage 530 and the total IO usage 540 for the determined at least one second process (Step S760). In more detail, the group process information generating unit 120 may assign the group process identifier 510 for the second process having the same pattern parameter 520 and may calculate the total CPU usage 530 and the total IO usage 540 for the group process identifier 510 to generate the data.

For example, in FIG. 5, the group process information generating unit 120 may assign the group process identifier 510 {PGROUP1} for the second process having the pattern parameter 410 {−x} in the process information illustrated in FIG. 4. Herein, the group process information generating unit 120 may calculate the total CPU usage 530 and the total IO usage 540 for the group process identifier {PGROUP1} to generate the data corresponding to {10+8+30} and {500+200+1500}. In one embodiment, when the pattern parameter 520 corresponds to {none}, the group process information generating unit 120 may calculate the total CPU usage 530 and the total IO usage 540 for the second process including all processes to generate the data and the processes do not include the set pattern parameter 520.

The resource monitoring unit 130 may monitor the resource of the computing apparatus by the generated first group process information (Step S770). In more detail, the resource monitoring unit 130 may monitor the CPU usage 320 and the IO usage 330 by the first group process information defined to the same process user 220 and the process name 230 from the executed processes on the computing apparatus 100. For example, in FIG. 3, the resource monitoring unit 130 may monitor the data value of {18} and {700} corresponding to the total CPU usage 320 and the total IO usage 330 for the messenger process executed by the USER1.

In one embodiment, the resource monitoring unit 130 may monitor the resource of the computing apparatus 100 by the generated second group process information. In more detail, the resource monitoring unit 130 may monitor the total CPU usage 530 and the total IO usage 540 by the second group process information having the same pattern parameter 520 of the process group parameter 410. For example, in FIG. 5, the resource monitoring unit 130 may monitor the data value of {48} and {2200} corresponding to the total CPU usage 530 and the total 10 usage 540 of the group process identifier 510 {PGROUP1}. That is, when the process group parameter 410 corresponds to the process argument, the resource monitoring unit 130 may monitor the processes by a group and the processes include the pattern parameter (e.g. a specific characteristic string) set by the resource monitoring manager of the process argument.

In another embodiment, the resource monitoring unit 130 may exclude the process in the second group process information from the generated first group process information to monitor the computing apparatus by the first group process information recalculated by the total CPU usage 610 and the total IO usage 620.

For example, in FIG. 6, the rest process excluding the process in the second group process information from the first group process information illustrated in FIG. 3 corresponds to the process identifier {10001} and {10072}. Herein, the group process information generating unit 120 may calculate the total CPU usage 610 and the total IO usage 620 corresponding to the process identifier {10001} and {10072} to generate the date corresponding to {20+11} and {1000+150} and the resource monitoring unit 130 may monitor the recalculated total CPU usage 610 and total IO usage 620. That is, the resource monitoring unit 130 may monitor the rest process by one group and the rest process do not have the pattern parameter (e.g. a specific characteristic string) set by the resource monitoring manager of the first group process information.

The resource monitoring unit 130 may repeat the Step S710 through S770 by a specific period or upon a user request. In one embodiment, the resource monitoring unit 130 may repeat the Step S710 through S770 by the specific period defined by a user. In another embodiment, the resource monitoring unit 130 may receive a user request to repeat the Step S710 through S770.

Although embodiments have been described with reference to a number of illustrative embodiments thereof, it should be understood that numerous other modifications and embodiments can be devised by those skilled in the art that will fall within the spirit and scope of the principles of this disclosure.

1. A resource monitoring method, the method being performed on a multitasking based computing apparatus, the method comprising:
(a) generating process information including a process identifier, a process user, a process name, a CPU usage and an IO(Input Output) usage when a computer program is executed and including a process group parameter to the process information, the process group parameter inputted with the process name in an execution procedure of the computer program;
(b) determining at least one first process having a same process user and same process name of a plurality of processes being currently executed;
(c) determining at least one second process from the process information, the at least one second process having a same pattern parameter of the process group parameter;
(d) generating first and second group process information including a group process identifier, a total CPU usage and a total IO(Input Output) usage for each of the determined at least one first and second processes; and
(e) monitoring the resource of the computing apparatus by the generated first and second group process information.

2. The resource monitoring method of claim 1, wherein the method further comprises repeating the (a) step through (e) step by a specific period or upon a user request.

3. The resource monitoring method of claim 1, wherein the (d) step further comprises excluding a process in the second group process information from the generated first group process information to recalculate the total CPU usage and the IO (Input Output) usage.

4. A multitasking based computing apparatus, the apparatus performing resource monitoring, the apparatus comprising:
a process information generating unit configured to generate a process information including a process identifier, a process user, a process name, a CPU usage and an IO(Input Output) usage when a computer program is executed and to include a process group parameter to the process information, the process group parameter inputted with the process name in the execution procedure of the computer program;
a group process information generating unit configured to determine at least one first process having a same process user and same process name of a plurality of processes being currently executed and to determine at least one second process from the process information, the at least one second process having a same pattern parameter of the process group parameter to generate first and second group process information including a group process identifier, a total CPU usage and a total IO(Input Output) usage for each of the determined at least one first and second processes; and
a resource monitoring unit configured to monitor the resource of the computing apparatus by the generated first and second group process information.

5. A multitasking based computing apparatus of claim 4, wherein the group process information generating unit excludes a process in the second group process information from the generated first group process information to recalculate the total CPU usage and the IO (Input Output) usage.
